(19) United States
(12) Patent Application Publication
(10) Pub. No.: US 2021/0309021 A1
(43) Pub. Date: Oct. 7, 2021

(54) THERMAL PRINTING DEVICE

(71) Applicant: CHIEN HWA COATING TECHNOLOGY, INC., Hsinchu City (TW)

(72) Inventors: YULUNG TSAO, HSINCHU CITY (TW); YIWEI LIN, HSINCHU CITY (TW); CHUNCHEN CHEN, HSINCHU CITY (TW)

(21) Appl. No.: 16/991,169

(22) Filed: Aug. 12, 2020

(30) Foreign Application Priority Data
Apr. 6, 2020 (TW) 109111443

(51) Int. Cl. B41J 2/335

(52) U.S. Cl. CPC B41J 2/33545; B41J 2/3359; B41J 2/3352

(57) ABSTRACT

The present invention relates to a thermal printing device, which comprises a circuit board and a plurality of heating components. A plurality of installation strips are disposed from the top down and horizontally on the circuit board. A plurality of first installation grooves are disposed in the plurality of installation strips. Each of the plurality of first installation grooves includes a first end and a second end. When being disposed from the top down, the first end of one of the plurality of first installation grooves located below is aligned with, the second end of one of the plurality of first installation grooves located above. The plurality of heating components are disposed in the plurality of first installation grooves, respectively. One end of one of the plurality of heating components is disposed on the same plane with the other end of one of the adjacent plurality of heating components in the radial direction. By using the above structure, the problem of fine seams between wide heating components can be solved and hence improving the printing quality.

### FIELD OF THE INVENTION

The present invention relates generally to a thermal printing device, and particularly to a thermal printing device with thermal components disposed in installation grooves and arranged in a ladder shape.

### BACKGROUND OF THE INVENTION

In the thermal printing area, according to the current technologies, a thermal device is generally adopted and assembled in installation. The principle of a thermal printer is to cover a transparent film over a light-colored material, which normally a sheet of paper. The film will turn dark (normally black or black) after being heated for a period. Images are formed by chemical reactions in the film through heating. This kind of chemical reactions is activated at a certain temperature. High temperatures will accelerate this chemical reactions. When the temperature is below 60□, it takes a quite long time, possibly as long as several years, for the film to turn dark. On the contrary, when the temperature is 200□, the chemical reactions will take place and finish in a few microseconds.

A thermal printer selectively heats on the specific locations of thermal paper and thus generating corresponding graphs. Heating is provided by a tiny electronic heater on the heating component contacting the thermal material. The heaters are arranged in square dots or strips and logically controlled by the printer. When the heaters are driven, a graph corresponding to the heating elements will be generated. The same logic circuit controlling the heating elements also controls paper feeding. Thereby, graphs can be printed on a whole tag or a sheet of paper. For the most common thermal printers, a fixed heating component with heating matrix is adopted. The printer can print dots at arbitrary locations using the matrix.

Nonetheless, when the fixed heating components with heating matrix as described above are assembled, there usually exists seams influencing the printing quality. Accordingly, the purpose of the present invention is to provide a thermal printing device capable of overcoming the seams between heating components as described above and thereby enhance the printing quality.

### SUMMARY

An objective of the present invention is to provide a thermal printing device for solving the problems of fine seams between wide heating components and deteriorated printing quality.

To achieve the above objective, the present invention discloses a thermal printing device, which comprises a circuit board and a plurality of heating components. A plurality of installation strips are disposed from the top down and horizontally on the circuit board. A plurality of first installation grooves are disposed in the plurality of installation strips. Each of the plurality of first installation grooves includes a first end and a second end. When being disposed from the top down, the first end of one of the plurality of first installation grooves located below is aligned with the second end of one of the plurality of first installation grooves located above. The plurality of heating components are disposed in the plurality of first installation grooves, respectively. One end of one of the plurality of heating components is disposed on the same plane with the other end of one of the adjacent plurality of heating components in the radial direction. The plurality of heating components are connected electrically to the circuit board. By using the above structure, the heating components are connected in order, which solves the problem of fine seams between wide heating components and hence improving the printing quality.

According to an embodiment of the present invention, the bottommost of the plurality of first installation grooves is a base installation groove. Using the base installation groove as the mirror axis, a plurality of second installation grooves corresponding to the plurality of first installation grooves are disposed in the plurality of installation strips. The plurality of heating components are disposed in the plurality of second installation grooves, respectively.

According to an embodiment of the present invention, the plurality of heating components are thermal heating components.

According to an embodiment of the present invention, a through hole is disposed horizontally in the plurality of installation strips, respectively.

According to an embodiment of the present invention, a spacer is disposed respectively on one side or both sides of the plurality of first installation grooves and the plurality of second installation grooves in the plurality of installation strips.

### BRIEF DESCRIPTION OF THE DRAWINGS

FIG. 1 shows a top view of the thermal printing device according to a first embodiment of the present invention;

FIG. 2A shows a partially enlarged view of the thermal printing device in FIG. 1 according to the present invention;

FIG. 2B shows a cross-sectional side view of the thermal printing device in FIG. 1 according to the present invention;

FIG. 3 shows a top view of the thermal printing device according to a second embodiment of the present invention;

FIG. 4A shows a partially enlarged view of the thermal printing device in FIG. 3 according to the present invention; and

FIG. 4B shows a cross-sectional side view of the thermal printing device in FIG. 3 according to the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present invention provides a thermal printing device for solving the problem of fine seams between wide heating components and hence improving the printing quality.

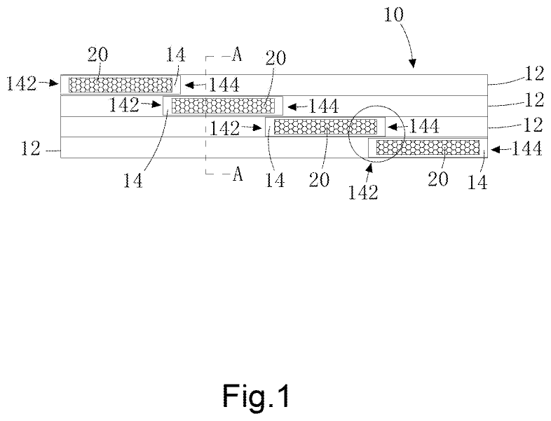

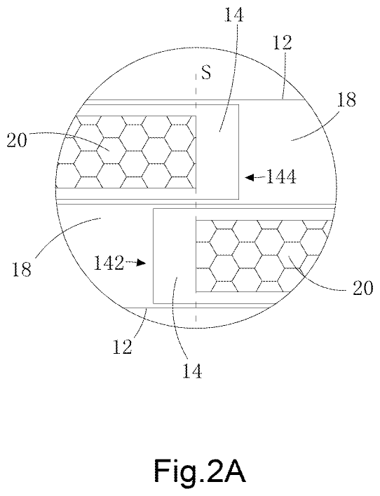

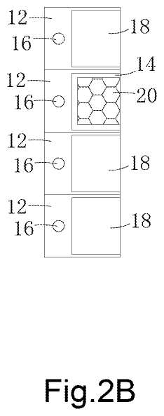

Please refer to FIGS. 1, 2A, and 2B, which show a top view of the thermal printing device and a partially enlarged view and a cross-sectional side view of the thermal printing device in FIG. 1 according a first embodiment of the present invention. As shown in the figures, according to the present embodiment, the thermal printing device according to the present invention comprises a circuit board 10 and a plurality of heating components 20. A plurality of installation strips 12 are disposed from the top down and horizontally on the circuit board 10. A plurality of first installation grooves 14 are disposed in the plurality of installation strips 12. Each of the plurality of first installation grooves 14 includes a first end 142 and a second end 144. When being disposed from the top down, the first end 142 of one of the plurality of first installation grooves 14 located below is aligned with the second end 144 of one of the plurality of first installation grooves 14 located above. The plurality of heating components 20 are disposed in the plurality of first installation grooves 14, respectively. One end of one of the plurality of heating components 20 is disposed on the same plane S with the other end of one of the adjacent plurality of heating components 20 in the radial direction. The plurality of heating components 20 are connected electrically to the circuit board 10. Specifically, one end of one of the plurality of first installation grooves 14 is orderly connected with the other end of one of the plurality of first installation grooves 14. In other words, the plurality of first installation grooves 14 are orderly and partially overlapped in the radial direction. Consequently, the plurality of heating components 20 will be orderly connected as well. By using the above structure, since the plurality of heating components 20 are disposed on the same plane with the adjacent heating components orderly, the gaps between the heat components 20 from the leftmost heating component 20 to the rightmost one can be avoided in the thermal printing device. Thereby, the problem of seams in the printed graphics or text after usage for a time can be solved and the printing quality can be improved.

Please continue to refer to FIGS. 1, 2A and 2B. As shown in the figures, according to the present embodiment, the plurality of heating components 20 are thermal heating components. A through hole 16 is disposed in the plurality of installation strips 12 corresponding to the plurality of heating components 20. Cooling liquid can be filled into the through hole 16 for cooling and avoiding damages due to overheating of the thermal printing device. In addition, a spacer 18 is disposed on one side or both sides corresponding to the plurality of first installation grooves 14 in the plurality of installation strips 12, respectively. In other words, in the plurality of installation strips 12, the spacers 18 are disposed in the regions without the plurality of first installation grooves 14. The height of the spacers 18 is identical to the height of the plurality of heating components 20 for protecting the plurality of heating components 20. By avoiding damages of the heating components caused by bumps from the sides, the lifetime of the thermal printing device will not be affected. In practical operations, the surface of the thermal paper is coated with solid dye and appropriate base material, such as fluorane-type invisible dye and octadecylphosphonic acid. When the base material is heated to the melting point, the dye reacts with the acid material and turns to the colored state, and thus achieves the purpose of printing. Accordingly, keeping the height of the spacers 18 identical to the height of the plurality of heating components 20 can protect the thermal paper in the printing process from damages caused by the plurality of heating components 20.

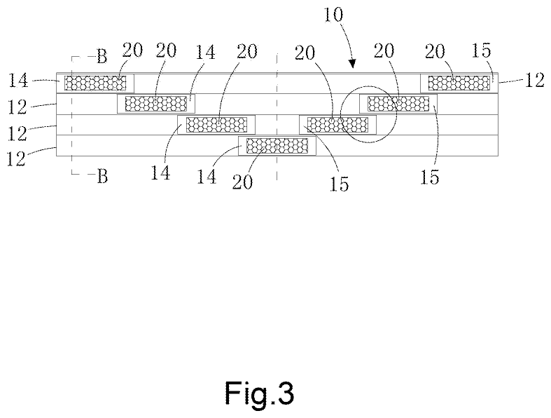

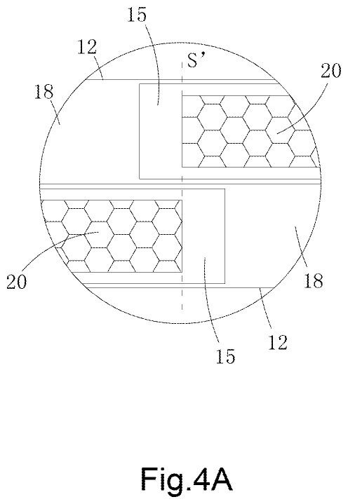

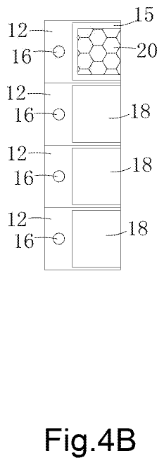

Please refer to FIGS. 3, 4A, and 4B, which show a top view of the thermal printing device and a partially enlarged view and a cross-sectional side view of the thermal printing device in FIG. 3 according to a first embodiment of the present invention. As shown in the figures, according to the present embodiment, the thermal printing device according to the present invention comprises a circuit board 10 and a plurality of heating components 20. A plurality of installation strips 12 are disposed from the top down and horizontally on the circuit board 10. A plurality of first installation grooves 14 are disposed in the plurality of installation strips 12. A gap between a right end of one of the plurality of first installation grooves 14 and a right end of the circuit board 10 decreases gradually from the top down and forming a ladder shape. The plurality of heating components 20 are disposed in the plurality of first installation grooves 14, respectively. According to the present embodiment, the bottommost of the plurality of first installation grooves 14 is a base installation groove. Using the base installation groove as the mirror axis, a plurality of second installation grooves 15 corresponding to the plurality of first installation grooves 14 are disposed in the plurality of installation strips 12. The plurality of heating components 20 are disposed in the plurality of second installation grooves 15, respectively. One end of one of the plurality of heating components 20 is disposed on the same plane S′ with the other end of one of the adjacent plurality of heating components 20 in the radial direction. Specifically, the plurality of heating components 20 will be connected in order. By using the above structure, since the plurality of heating components 20 are disposed on the same plane with the adjacent heating components orderly, the gaps between the heat components 20 from the leftmost heating component 20 to the rightmost one can be avoided in the thermal printing device. Thereby, the problem of seams in the printed graphs or text after usage for a time can be solved and the printing quality can be improved.

Please continue to refer to FIGS. 3, 4A, and 4B. As shown in the figures, according to the present embodiment, the plurality of heating components 20 are thermal heating components. A through hole 16 is disposed in the plurality of installation strips 12 corresponding to the plurality of heating components 20. A cooling liquid can be filled into the through hole 16 for cooling and avoiding damages due to overheating of the thermal printing device. In addition, a spacer 18 is disposed on one side or both sides corresponding to the plurality of first installation grooves 14 and the plurality of second installation grooves 15 in the plurality of installation strips 12, respectively. In other words, in the plurality of installation strips 12, the spacer 18 is disposed in the regions without the plurality of first installation grooves 14 or the plurality of second installation grooves 15. The height of the spacers 18 is identical to the height of the plurality of heating components 20 for protecting the plurality of heating components 20. By avoiding damages of the heating components caused by bumps from the sides, the lifetime of the thermal printing device will not be affected.

To sum up, the present invention discloses a thermal printing device, which comprises a circuit board 10 and a plurality of heating components 20. A plurality of installation strips 12 are disposed from the top down and horizontally on the circuit board 10. A plurality of first installation grooves 14 are disposed in the plurality of installation strips 12. The plurality of first installation grooves 14 are arranged in a ladder shape. The plurality of heating components 20 are disposed in the plurality of first installation grooves 14, respectively. One end of one of the plurality of heating components 20 is disposed on the same plane with the other end of one of the adjacent plurality of heating components 20 in the radial direction. By using the above structure, the heating components 20 are connected in order, hence solves the problem of fine seams between wide heating components and hence improving the printing quality.

What is claimed is:

1. A thermal printing device, comprising:
a circuit board, a plurality of installation strips disposed from the top down and horizontally on said circuit board, a plurality of first installation grooves disposed in said plurality of installation strips, each of said plurality of first installation grooves including a first end and a second end, and said first end of one of said plurality of first installation grooves below aligned with said second end of one of said plurality of first installation grooves above when being disposed from the top down; and
a plurality of heating components, disposed in said plurality of first installation grooves, respectively, one end of one of said plurality of heating components disposed on the same plane with the other end of one of said adjacent plurality of heating components in the radial direction, and said plurality of heating components connected electrically to said circuit board.

2. The thermal printing device of claim 1, wherein the bottommost of said plurality of first installation grooves is a base installation groove; using said base installation groove as the mirror axis, a plurality of second installation grooves corresponding to said plurality of first installation grooves are disposed in said plurality of installation strips; and said plurality of heating components are disposed in said plurality of second installation grooves, respectively.

3. The thermal printing device of claim 2, wherein said plurality of heating components are thermal heating components.

4. The thermal printing device of claim 1, wherein a through hole is disposed horizontally in said plurality of installation strips, respectively.

5. The thermal printing device of claim 2, wherein a spacer is disposed respectively on one side or both sides of said plurality of first installation grooves and said plurality of second installation grooves in said plurality of installation strips.
